(19) United States
(12) Patent Application Publication
(10) Pub. No.: US 2009/0303097 A1
(43) Pub. Date: Dec. 10, 2009

(54) SYSTEMS, METHODS AND APPARATUS FOR CHANGING AN OPERATIONAL MODE OF A REMOTE CONTROL

(75) Inventors: William R. Reams, Englewood, CO (US); William M. Beals, Englewood, CO (US)

Correspondence Address: EchoStar Technologies, L.L.C.;Legal Department, 9601 SOUTH MERIDIAN BOULEVARD, ENGLEWOOD, CO, 80112, US

(73) Assignee: Echostar Technologies LLC, Englewood, CO (US)

(21) Appl. No.: 12/135,370

(22) Filed: Jun. 9, 2008

(51) Int. Cl. H04L 17/02

(52) U.S. Cl. 341/176

(57) ABSTRACT

Various embodiments of systems, methods and apparatus are provided for changing an operational mode of a remote control for a controlled device. A remote control queries a controlled device to determine the operating state of the controlled device. Responsive to determining the operating state of the controlled device, the remote control determines whether to enter an active mode state and/or limited power mode state. Components of the remote control may then be commanded to enter a selected operating mode state depending on whether the components are utilized by the present operational state of the controlled device.

### BACKGROUND

Entertainment devices, such as televisions, television receivers (e.g., set-top boxes) and media servers have become very complicated, supporting a wide variety of feature sets. Simple remote controls with a number pad and a handful of assorted feature buttons (e.g., volume changes, channel changes, power and mute) are no longer adequate to support the enhanced feature sets available on many entertainment devices. To allow user navigation of newer feature sets on entertainment devices, advanced remote controls have been developed that provide various techniques for users to input information to the entertainment device. For example, some remote controls include touch pads or other positional input devices allowing a user to control a cursor presented on screen by an entertainment device. However, touch pads and other similar components require relatively more power than simple keypads of remote controls.

The power drawn by these devices significantly shortens the battery life of the remote control. To conserve power, a remote may place components into a limited power mode state (e.g., a sleep mode state) when not needed. For example, a touch pad may be placed into a sleep mode state when a menu is not being presented by the entertainment device. Further, a transmitter or transceiver of a remote control may be idle when not needed for transmitting or receiving data. However, determining when to place components of a remote control into limited power mode state, as well as determining when to wake up components, is a problem. One solution is for the entertainment device to transmit sleep signals and wake-up signals to a remote control. When in a limited power mode state, the remote control periodically wakes up to receive messages from the entertainment device. However, the entertainment device may need to repeatedly transmit messages to the remote control so that the message is actually received by the remote control during one of the periodic waking intervals. This is adequate for infrared data links, but may be inappropriate for other types of data links, such as radio frequency (RF) links, because the repeated transmissions may cause interference with other devices.

### BRIEF DESCRIPTION OF THE DRAWINGS

The same number represents the same element or same type of element in all drawings.

FIG. 1 illustrates an embodiment of an entertainment system.

FIG. 2 illustrates an embodiment of a remote control of the entertainment system of FIG. 1.

FIG. 3 illustrates an embodiment of an entertainment device of FIG. 1.

FIG. 4 illustrates an embodiment of a process for placing a remote control in a limited power mode state.

FIG. 5 illustrates an embodiment of a process for a remote control to enter an active mode state.

### DETAILED DESCRIPTION

The various embodiments described herein generally provide apparatus, systems and methods for placing components of a remote control into active or limited power mode states depending on the operational state of a controlled device. More particularly, the various embodiments described herein generally provide a remote control that queries a controlled device for the operational state of the controlled device, and further determines an operational state of the remote control based on the received information. Thus, the remote control may determine an appropriate operational state of components based upon whether the components are needed for the present operational state of the controlled device.

In at least one embodiment, a remote control queries a controlled device for an operational state, and based upon a response from the controlled device, determines whether to enter a limited power mode state from an active mode state. For example, user input circuitry (e.g., a touch pad or other input device) may be placed into a limited power mode state if the user input circuitry is not presently needed by the entertainment device. As used herein, a limited power mode state may refer to any reduced power state of components of a remote control, including a standby state, a sleep mode state, or an off state. The user input circuitry may subsequently be commanded to enter an active mode state from the limited power mode state if the operational state of the entertainment device changes such that the user input circuitry may be needed to receive user input. For example, the remote control may periodically query the controlled device for changes to the operational state of the controlled device. If there are no changes to the -operational state, then the remote control may return to the limited power mode state for a specified interval until another query is performed. In some embodiments, other components, such as the transceiver of the remote control, backlighting components and the like may be placed in a limited power mode state based upon the operating state of the remote control. For example, a controlled device may be turned off, and as such, it may be unnecessary to operate particular components of the remote control.

The controlled device is described herein as an entertainment device. However, it is to be appreciated that the teachings described herein may be applied to other combinations of remote controls and controlled devices. For example, the teachings described herein may be applied to household appliances, computers and wireless peripherals (e.g., keyboards, mice and pointing devices), automobile keyless entry systems and the like.

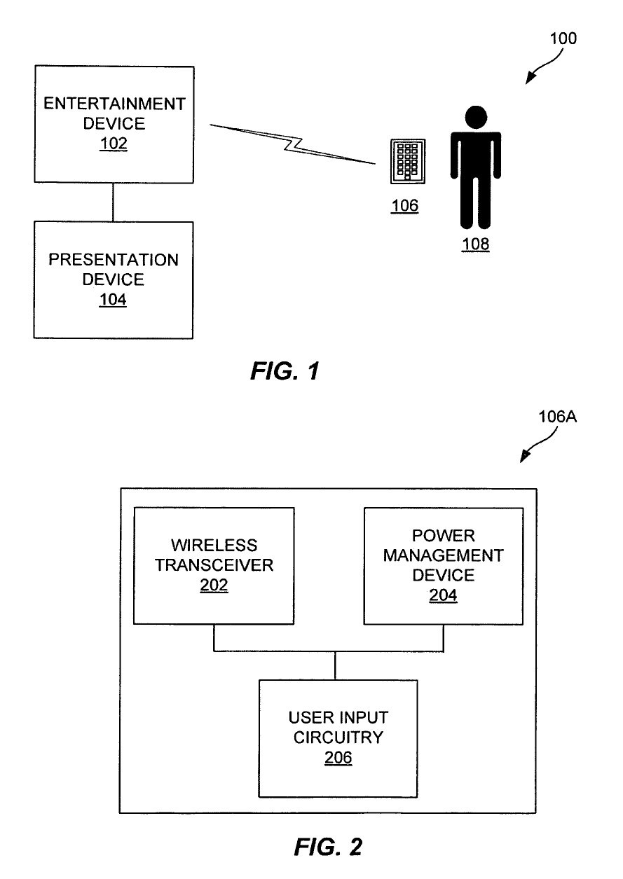

FIG. 1 illustrates an embodiment of an entertainment system 100. The entertainment system 100 presents content to a user 108. In at least one embodiment, the content presented to the user 108 includes an audio/video stream, such as a television program, movie or other recorded content and the like. The entertainment system 100 includes an entertainment device 102, a presentation device 104 and a remote control 106. Each of these components is discussed in greater detail below. The entertainment system 100 may include other devices, components or elements not illustrated for the sake of brevity.

The entertainment device 102 is operable to receive-content from one or more content sources (not shown in FIG. 1), and to present the received content to the user 108 on the associated presentation device 104. In at least one embodiment, the presentation device 104 is a display device (e.g., a television) configured to display content to the user 108. The entertainment device 102 may receive an audio/video stream in any format (e.g., analog or digital format), and output the audio/video stream for presentation by the presentation device 104. The entertainment device 102 may be further configured to display menus and other information that allow a user 108 to control the output of content by the entertainment device 102. In at least one embodiment, the entertainment device 102 is a set-top box (e.g., a satellite or cable television converter box), digital video recorder (DVR) or other similar device that processes and provides one or more audio and/or video output streams to the presentation device 104 for presentation to the user 108. In some embodiments, the entertainment device 102 and the presentation device 104 may be integrated as a device combining the functionality of a display device and a set-top box, digital video recorder (DVR) or the like.

The entertainment device 102 has multiple operating states, corresponding with different available functionalities. For example, a first operating state may correspond with a powered-on state, whereas a second operating state may correspond with a powered-off state. In some embodiments, a first operating state is associated with the entertainment device 102 outputting a menu navigable with the remote control 106.

The remote control 106 may comprise any system or apparatus configured to remotely control the output of content by the entertainment device 102. For example, the remote control 106 may communicate commands to the entertainment device 102 requesting to playback content, temporally move through content (e.g., fast-forward or reverse), adjust the volume, access electronic programming guides, menus and the like. In some embodiments, the remote control 106 may additionally be configured to remotely control the presentation device 104. The remote control 106 may communicate with the entertainment device 102 and/or the presentation device 104 through any type of wireless communication medium, such as infrared (IR) signals or radio-frequency (RF) signals.

The remote control 106 is configured to periodically enter a limited power mode state (e.g., a sleep mode state or stand-by mode state) to conserve battery power. More particularly, components of the remote control 106, such as processors, user input circuitry, transceivers, backlighting, display screens and the like may be commanded to enter a limited power mode state when the functionality of the components is not needed by the entertainment system 100. For example, the remote control 106 may enter a sleep mode state when the entertainment device 102 is powered off. Particular components of the remote control may also enter a limited power mode state if the entertainment device 102 is in an operational state that does not involve soliciting input from a user via the remote control 106.

In at least one embodiment, the remote control 106 queries the entertainment device 102 to determine whether to enter a limited power mode state while operating in an active mode state. For example, the remote control 106 may operate in an active mode state that includes utilizing a touch pad input device in an active mode state to solicit user input for controlling a menu outputted by the entertainment device 102 for presentation on the presentation device. 104. While the touch pad input device operates in the active mode state, the remote control 106 may periodically query the entertainment device 102 to determine whether the entertainment device 102 is still operating in a state that utilizes the touch pad input device. If the operating state of the entertainment device 102 does not need to utilize the touch pad input device (e.g., the entertainment device 102 is no longer outputting a menu), then the remote control 106 may command the touch pad input device to enter a limited power mode state.

In another embodiment, the remote control 106 may operate in an active mode state, and may query the remote control and receive a response indicating that the entertainment device 102 has been powered off. For example, the user 108 may have powered off the entertainment device 102 using a front console of the entertainment device 102. Thus, the components of the remote control 106 may enter a limited power mode state, periodically waking to query the entertainment device 102 for operational mode changes (e.g., powering on the entertainment device 102). If an operational mode change is detected by the remote control 106, then appropriate components of the remote control 106 may be commanded to enter an active mode state corresponding with the operational state of the entertainment device 102.

FIG. 2 illustrates an embodiment of a remote control 106A of the entertainment system 100 of FIG. 1. FIG. 2 will be discussed in reference to the entertainment system 100 illustrated in FIG. 1. The remote control 106A includes a wireless transceiver 202, a power management device 204 and user input circuitry 206. Each of these components is discussed in greater detail below. The remote control 106A may contain other devices, such as display screens, backlighting and non-volatile memory, not mentioned herein for the sake of brevity.

The user input circuitry 206 is operable to receive and/or process user input from the user 108 (see FIG. 1). In at least one embodiment, the user input circuitry 206 is a keypad including a set of buttons. The user 108 may utilize the keypad to input channel numbers, control the volume of the entertainment device 102, navigate menus, manipulate the output of content by the entertainment device 102 and/or control other functions of the entertainment device 102 and/or the presentation device 104. The user input circuitry 206 may further include a processor operable to generate control commands for the entertainment device 102 responsive to the user input. The control commands may be in the form of key codes that are compatible with the entertainment device 102.

In at least one embodiment, the user input circuitry 206 comprises a positional information input device configured to solicit positional information from the user 108. The positional information input device receives motion input from the user 108, and translates the motion input into positional information utilized to generate commands for the entertainment device 102. For example, the positional information may be utilized to navigate an onscreen menu outputted by the entertainment device 102. More particularly, the motion input is utilized to position a cursor of the menu, and/or to make selections within the menu. In some embodiments, motion input may be utilized to change channels of the entertainment device 102. It is to be appreciated that motion input may be utilized to generate commands for a plurality of functions of the entertainment device 102. Exemplary motion detector devices include mechanical switches, gyroscopes and accelerometers. Motion detectors may be utilized-that detect motion, vibration or acceleration among any number of axis. For example, a three element accelerometer may be utilized for detecting accelerations along an x, y and z axis.

The wireless transceiver 202 is operable to bi-directionally communicate with the entertainment device 102 and/or the presentation device 104. More particularly, the wireless transceiver 202 is operable to transmit a key code and/or command message corresponding with user input to the entertainment device 102. The wireless transceiver 202 is also operable to exchange other data with the, entertainment device 102, such as operational status queries and responses. The wireless transceiver 202 may utilize any type of wireless protocol and wireless communication medium, including RF or IR key codes, to communicate with the entertainment device 102 (see FIG. 1) and/or the presentation device 104. The remote control 106A may also receive IR database key codes, RF database key codes or firmware updates from the entertainment device 102.

The remote control 106A further includes a power management device 204 operable to control the power consumption of the remote control 106A. In other words, the power management device 204 is operable to command various components of the remote control 106A, such as the user input circuitry 206 and/or the wireless transceiver 202, to enter or exit a limited power mode state depending on the operational state of the entertainment device 102. The power management device 204 may be embodied as a separate hardware device within the remote control 106A, or may be embodied as software operating on a general purpose processor the remote control 106A.

To determine whether to command the various components of the remote control 106A to enter a limited power mode state, the power management device 204 generates an operational state query for the entertainment device 102. The wireless transceiver 202 transmits the operational state query to the entertainment device 102 and responsively receives an operational state response. The operational state response identifies the present operating state of the entertainment device 102. For example, the operational state response may identify either a first operating state (powered-on state) or a second operating state (powered-off state). The operational state response may further differentiate between various powered-on states of the entertainment device 102, such as displaying a menu on-screen or outputting video content to the presentation device 104. The differentiation between the various powered-on states allows the power management device 204 to determine which components (if any) of the remote control 106A are needed to support the present operating state of the entertainment device 102.

The power management device 204 processes the operational state response from the entertainment device 102 to determine the present operating state of the entertainment device 102. More particularly, in at least one embodiment, the power management device 204 commands the user input circuitry 206 to enter a limited power mode state responsive to determining that the controlled device is operating in a specified operating state. For example, the specified operating state may be a powered-off state. Thus, the user input circuitry 206 transitions from the active mode state to the limited power mode state to conserve battery power. If the operating state of the entertainment device 102 involves utilizing the user input circuitry 206 to receive user input, then the power management device 204 may command the user input circuitry 206 to remain in an active mode state.

Similarly, if the user input circuitry 206 is presently operating in a limited power mode state, then the power management device 204 may command the user input circuitry to enter an active mode state from the limited power mode state responsive to determining that the controlled device is operating in a particular operating state. For example, the user input circuitry 206 may comprise a positional information input device (e.g., a touch pad) utilized to input information associated with a menu outputted by the entertainment device 102. If the entertainment device 102 transitions from a first operating state (e.g., displaying video) to a second operating state (e.g., displaying a menu) that utilizes the input collected by the user input circuitry 206, then the power management device 204 may command the user input circuitry 206 to enter the active mode state to collect user input from the user 108.

In at least one embodiment, the components of the remote control 106A may be placed in a limited power mode state when the entertainment device 102 is operating in a specified state, and the power management device 204 may periodically query the entertainment device 102 for changes to the operating state. For example, the power management device 204 may wake-up according to specified intervals to query the entertainment device 102 for operational state status changes. If there are no changes, then the power management device 204 may again enter the limited power mode state. However, if there is an operational state change of the entertainment device 102, then the power management device 204 may command the components of the remote control 106A, such as the user input circuitry 206 and/or the wireless transceiver 202 to enter an active mode state to communicate with the entertainment device 102.

During idle intervals, the power management device 204 may command the wireless transceiver 202 to enter a limited power mode state until data is available for exchange with the entertainment device 102. Further, the period of time between queries may be selected based on various design criteria. For example, it may take approximately 10 seconds for the user 108 to turn on the entertainment device 102 via a front panel console and walk to the couch to retrieve the remote control 106 for changing channels. Thus, it may be appropriate to select the interval as 10 seconds to ensure that the user input circuitry 206 is available to process input from the user 108 when the user 108 is ready to utilize the remote control 106.

In other embodiments, it may be appropriate to select the query interval depending on a particular operating state of the remote control. For example, if the user 108 is watching television, it may be appropriate to query for operational changes every 15 seconds to ensure that the user input circuitry 206 is available for use by the user 108 if a menu or other function is outputted by the entertainment device 102. On the other hand, if the entertainment device 102 is downloading data, such as electronic programming guide data or video data, which may take several minutes to complete, then it may be appropriate to select the query interval to coincide with the end of the download of the data, because it may be unnecessary for the remote control 106A to be in an operating state if the user 108 is unable to input data to the entertainment device 102 during the selected interval.

In at least one embodiment, the power management device 204 may be configured to adjust the query interval depending on other criteria, such as the length between status changes, viewing characteristics, idle time of an entertainment device or the time of day. Adjustment of the time interval may be performed based on information exchanged with the entertainment device 102. For example, if the entertainment device 102 and/or the power management device 204 determine that the entertainment device 102 is not used during the hours of 10 PM through 6 AM, then it may be appropriate to select a longer query interval during these hours than when the user is more likely to be utilizing the entertainment device. Therefore, a status query interval of 1 minute, 5 minutes, 10 minutes or an 1 hour may be appropriate for the night time period, whereas a status query interval of 10 seconds may be more appropriate during the day time, when the user is more likely to be watching TV, and thus more likely to utilize the remote control 106A.

The status query interval may also be configured based on the length of time between status changes. For example, if the power management device 204 determines that it has been two days between status changes or any use of the user input circuitry 206, then it may be likely that the user 108 is presently on vacation. Thus, it may be appropriate for the power management device 204 to transition from a first limited power mode state to a second limited power mode state, with the second limited power mode state having a longer interval before waking-up (i.e., a deeper sleep mode). This allows the remote control 106A to eliminate powering components when unnecessary, prolonging the life of the batteries in the remote control 106A.

In at least one embodiment, the entertainment device 102 is configured to transmit data, such as key code databases, software updates, user settings and the like to the remote control 106A. Thus, at least one operating state of the remote control 106A may indicate that the entertainment device 102 is ready to transmit data to the wireless transceiver 202. Optimally, software/firmware updates are performed when the user 108 is not utilizing the remote control 106A to avoid disrupting the viewing experience of the user 108. For example, software updates may be performed late at night (or during other times of the day depending on viewing characteristics), and the remote control 106A may be initially operating in a limited power mode state when the update becomes available. The power management device 204 may transition from a limited power mode state to a query mode state and transmit an operational state query to the entertainment device 102. The entertainment device 102 transmits an operational state response indicating that the software update is ready for transmission, and the power management device 204 commands the wireless transceiver 202 and/or the user input circuitry 206 to transition to an active mode state in order to receive and process the data transmitted by the entertainment device 102.

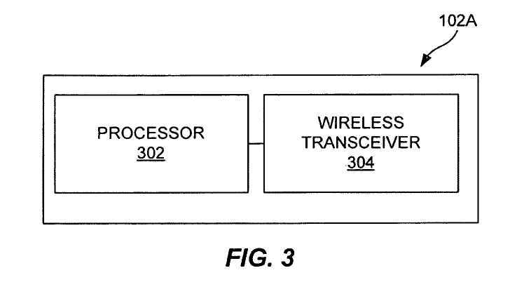

FIG. 3 illustrates an embodiment of an entertainment device 102A of FIG. 1. More particularly, FIG. 3 illustrates an entertainment device 102A embodied as a television receiver (e.g., a set-top box). However, it is to be appreciated that the entertainment device 102A may comprise any type of device that presents any type of presentation content. FIG. 3 will be discussed in reference to the entertainment system 100 illustrated in FIG. 1. The entertainment device 102A includes a processor 302 and wireless transceiver 304. Each of these components will be discussed in greater detail below. The entertainment device 102A may include other components or devices not illustrated for the sake of brevity.

The processor 302 is operable for controlling the operation of the entertainment device 102A. The processor 302 may also be referred to herein as an output interface for video content. As used herein, a processor 302 refers to a single processing device or a group of inter-operational processing devices. The operation of the processor 302 may be controlled by instructions executable by the processor 302. Some examples of instructions are software, program code, and firmware. Additionally, the operation of particular functionalities of the processor 302 are controllable based on commands received from a remote control 106. In at least one embodiment, the processor 302 includes at least a first operating state and a second operating state. The operating states may be of any type as described above.

In at least one embodiment, the processor 302 is operable for receiving presentation content, e.g., video content. The processor 302 may be operable for receiving and tuning any type of video content. For example, the processor 302 may receive an over-the-air broadcast signal, a direct broadcast satellite signal or a cable television signal. The processor 302 may-receive or retrieve content from a storage medium, such as an optical disk, internal or external hard drive, a portable storage device (e.g., universal serial bus (USB) memory sticks) and the like. The processor 302 may also receive content from external servers, such as video servers, that are communicatively coupled to the entertainment device 102A over the internet or other types of data networks.

The processor 302 may operate to perform various signal and data processing functions such as demodulation, decoding, decryption and the like on data signals received via any type of network interface, to generate an appropriate format video stream for output to the presentation device 104 (see FIG. 1). The processor 302 may comprise multiple components, such as a demodulator, an audio decoder, a video decoder, a data decoder or a graphics processor to generate the video stream. Commands received from the remote control 106 are operable to control the output of audio and video content by the processor 302. For example, the transceiver 304 may receive a key code causing processor 302 to manipulate the output of the video content responsive to the key code. The processor 302 operates to output a video stream for presentation by the presentation device 104. The video stream generated-by the processor 302 may include menus, electronic programming guides and the like that is navigable using commands received from the remote control 106.

The wireless transceiver 304 is operable to wirelessly receive and/or transmit data to the remote control 106. The wireless transceiver 304 may communicate with the remote control 106 utilizing any type of IR or RF communication link. In at least one embodiment, the wireless transceiver 304 receives a key code from the remote control 106, and responsively provides the key code to the processor 302. The wireless transceiver 304 is further operable-to exchange data with the remote control 106, such as IR database code updates, firmware updates and the like.

The wireless transceiver 304 is further operable to exchange operational state queries and operational state responses with the remote control 106. For example, the remote control 106 transmits an operational state query to the wireless transceiver 304. The wireless transceiver 304 receives the operational state response to the query from the processor 302 and transmits the operational state response to the remote control 106. Thus, the remote control 106 utilizes the operational state response, as described above, to determine whether to transition to or from a limited power mode state.

In some embodiments, the entertainment device 102A may be configured to output multiple independent content streams to different presentation devices. For example, the entertainment device 102A may comprise a satellite television receiver with two independent tuners that are each associated with independent output interfaces. Thus, a first output interface may output a first television program for presentation on a first television, whereas a second output interface may output a second television program for presentation on a second television. Each tuner and output interface may be further associated with independent remote controls that allow users to control the output of content. In accordance with the teachings above, a remote control may be placed into a limited power mode and/or active mode state based on the operational state of the associated tuner and/or output interface.

For example, a first tuner may be idle, and thus, the first remote control may be placed into a limited power mode state responsive to an operational mode query/response to an entertainment device. By contrast, a second tuner may be active and outputting content to a second television, and the second remote control may continue to operate in an active mode state. Thus, operational mode queries to the entertainment device by each remote control may result in different operational state responses by the entertainment device.

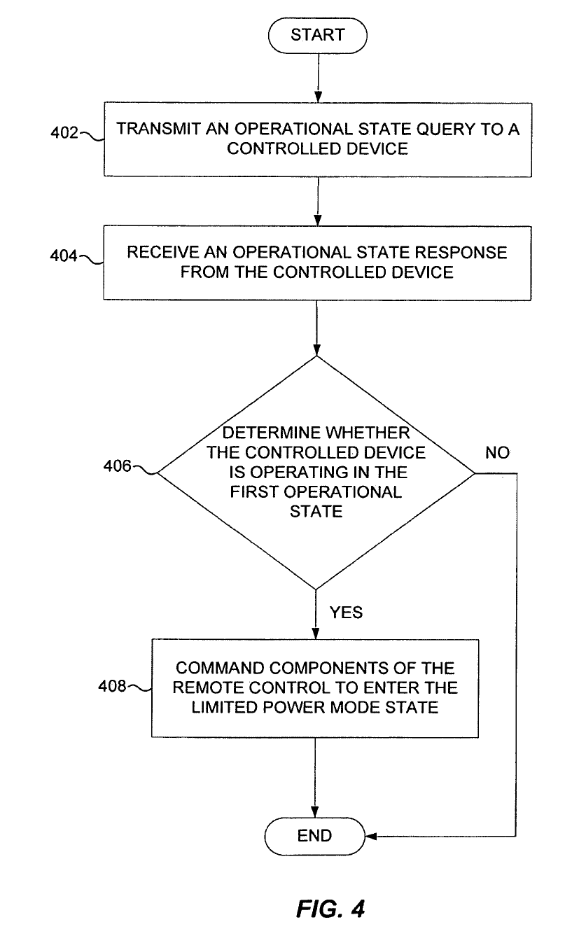

FIG. 4 illustrates an embodiment of a process for placing a remote control in a limited power mode state. The process of FIG. 4 will be discussed in reference to a television receiver. However, it is to be appreciated that the process may be applied to remote controls for other types of controlled devices. The process of FIG. 4 is not all inclusive, and may include other operations not illustrated for the sake of brevity.

The process includes transmitting an operational state query to a television receiver (operation 402). The television receiver has at least two distinct operating states including a first operating state and a second operating state. The operating states may be associated with any type of functionality of the television receiver (or disablement of specific functionalities of the television receiver). The operational state query may be transmitted at any time, and may be transmitted responsive to a specified event or responsive to a timer having a specified interval.

The process further includes receiving an operational state response from the television receiver (operation 404). Responsive to receiving the operational state response, the process includes determining whether the television receiver is operating in a first specified operating state (operation 406). If the television receiver is operating in the first operational state, then the process further includes commanding components of the remote control to enter a limited power mode state (operation 408). For example, if a menu is not outputted for presentation by the television receiver, then a pointing device may be placed into a limited power mode state. However, if the television receiver is determined to be operating in the second operating state, then the process ends, and the remote control remains in its present operating state (e.g., an active mode state).

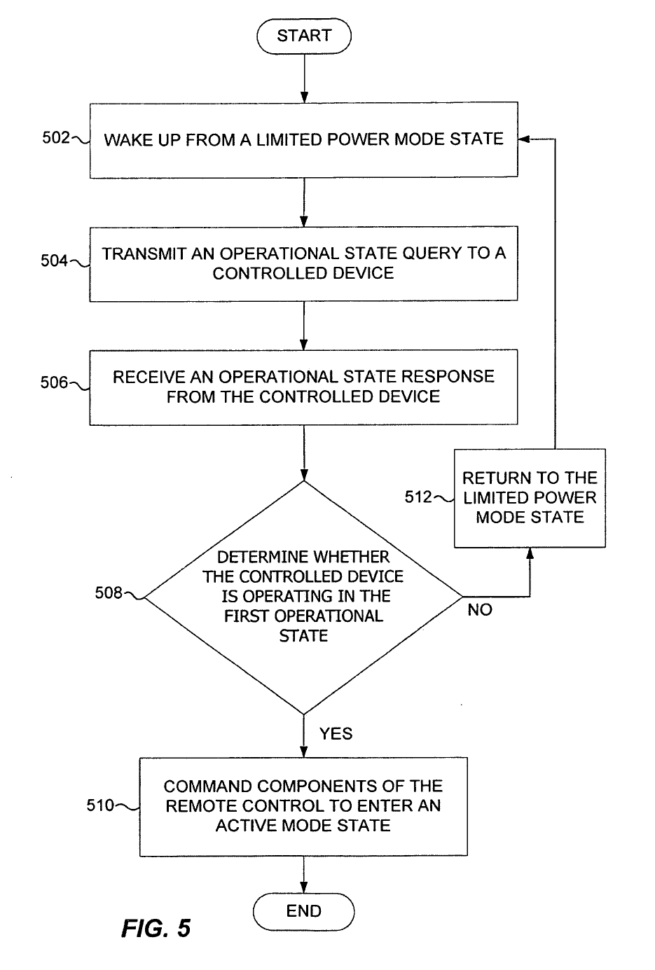

FIG. 5 illustrates an embodiment of a process for a remote control to enter an active mode state. The process of FIG. 5 will be discussed in reference to a television receiver. However, it is to be appreciated that the process may be applied to remote controls for other types of devices. The process of FIG. 5 is not all inclusive, and may include other operations not illustrated for the sake of brevity.

The process includes waking up a remote control from a limited power mode state (operation 502). In at least one embodiment, the remote control may completely wake-up from the limited power mode state into the active mode state. Alternatively, specific components of the remote control, such as a power management module and/or a transceiver may wake-up from the limited power mode state into the active mode state or a query mode state. In at least one embodiment, the wake up function of operation 502 may be performed according to a specified interval controlled by a timer.

The process further includes transmitting an operational state query to a television receiver (operation 504). Operation 504 may be performed as described above in operation 402. The process further includes receiving an operational state response from the television receiver (operation 506). Operation 506 may be performed as described above in operation 404.

Responsive to receiving the operational state response, the process includes determining whether the television receiver is operating in a first specified operating state (operation 508). If the television receiver is operating in the first operational state, then the process further includes commanding components of the remote control to enter an active mode state (operation 510). However, if the television receiver is determined to be operating in the second operating state, then the remote control may return to its original mode (e.g., a sleep mode state) in step 512. The remote control may periodically repeat-the process of FIG. 5 until such time as the television receiver enters an operating state that corresponds with placing the components of the remote control into an active mode state.

Although specific embodiments were described herein, the scope of the invention is not limited to those specific embodiments. The scope of the invention is defined by the following claims and any equivalents therein.

We claim:

1. A remote control comprising:
user input circuitry that processes user input to generate a control command for a controlled device;
a power management device that generates a first operational state query for the controlled device, wherein the controlled device has at least a first operating state and a second operating state; and
a wireless transceiver coupled to the power management device and coupled to the user input circuitry-that transmits the control command to the controlled device and that further transmits the first operational state query to the controlled device and responsively receives a first operational state response to the first operational state query;
the power management device processing the first operational state response to determine whether the controlled device is operating in the first operating state, and that further commands the user input circuitry to enter a limited power mode state responsive to determining that the controlled device is operating in the first operating state.

2. The remote control of claim 1, wherein the user input circuitry comprises a positional information input device.

3. The remote control of claim 2, wherein the second operational state includes outputting a menu utilized in association with the positional information input device.

4. The remote control of claim 1, wherein:
the power management device generates a second operational state query for transmission by the transceiver to the controlled device while the user input circuitry operates in the limited power mode state;
the transceiver receives a second operational state response to the second operational state query;
the power management device processes the second operational state response to determine whether the controlled device is operating in the second operating state, and that further commands the user input circuitry to enter an active mode state responsive to determining that the controlled device is operating in the second operating state.

5. The remote control of claim 4, wherein the power management device adjusts a time period before transmitting a third operational state query to the controlled device based on the second operational state response.

6. The remote control of claim 4, wherein the controlled device comprises a television receiver and wherein the power management device determines a time interval between transmission of the first operational state query and the second operational state query based on viewing characteristics of a user of the television receiver.

7. The remote control of claim 4, wherein the power management device determines a time interval between transmission of the first operational state query and the second operational state query based upon a length of time that the controlled device has been idle.

8. The remote control of claim 4, wherein the second operational state indicates that the controlled device is ready to transmit data to the remote control, and wherein the user input circuitry processes the data in the active mode state.

9. A remote control comprising:
user input circuitry that processes user input to generate control commands for a controlled device, the user input circuitry operating in a limited power mode state;
a power management device that generates a first operational state query for the controlled device, wherein the controlled device has at least a first operating state and a second operating state; and
a wireless transceiver coupled to the power management device that transmits the first operational state query to the controlled device and responsively receives a first operational state response to the first operational state query;
the power management device processing the first operational state response to determine whether the controlled device is operating in the first operating state, and that further commands the user input circuitry to enter an active mode state responsive to determining that the controlled device is operating in the first operating state.

10. The remote control of claim 9, wherein the power management device configures a timer for transmitting a second operational state query responsive to determining that the controlled device is operating in the second operating state.

11. The remote control of claim 10, wherein a period of the timer is configured based on the second operating state of the controlled device.

12. The remote control of claim 10, wherein the controlled device comprises a television receiver and wherein a period of the timer is configured based on viewing characteristics of a user of the television receiver.

13. The remote control of claim 10, wherein the period of the timer is configured based on a time of day.

14. The remote control of claim 10 wherein the period of the timer is configured based upon a length of time that the controlled device has been idle.

15. The remote control of claim 9, wherein the power management device commands the user input circuitry to enter a second limited power mode state responsive to determining that the controlled device is operating in a third operating state.

16. An apparatus comprising:
a processor having functionality controllable based on commands received from a wireless remote control, the processor including at least a first operating state and a second operating state; and
a wireless transceiver communicatively coupled to the wireless remote control, the wireless transceiver receiving an operational state query from the wireless remote control, and further transmitting an operational state response to the wireless remote control specifying the operational state of the processor, wherein the wireless remote control enters a limited power mode state responsive to determining that the processor is operating in the first operating state, based on the operational state response.

17. The apparatus of claim 16, wherein the processor outputs a menu in the presentation stream while operating in the second operating state and outputs a cursor of the menu based on positional information received from the wireless remote control.

18. A system comprising:
an entertainment device including:
an output interface that outputs a presentation stream for presentation on a presentation device, the output interface having at least a first operating state and a second operating state; and
a first wireless transceiver;
a first remote control including:
user input circuitry that processes user input to generate a control command that controls the output of the presentation stream by the output interface;
a power management device that generates a first operational state query for the entertainment device; and
a second wireless transceiver coupled to the power management device and coupled to the user input circuitry that transmits the control command to the first wireless transceiver and that further transmits the first operational state query to the first wireless transceiver and responsively receives a first operational state response to the first operational state query;
the power management device processing the first operational state response to determine whether the output interface is operating in the first operating state, and that further commands the user input circuitry to enter a limited power mode state responsive to determining that the controlled device is operating in the first operating state.

19. The system of claim 18, wherein:
the output interface outputs video content in the presentation stream while in the first operational state;
the output interface outputs a menu in the presentation stream while in the second operational state; and
the output interface outputs a cursor of the menu based on positional information supplied by the user input circuitry.

20. The system of claim 19, wherein the user input circuitry comprises a touch pad.

21. The system of claim 19, wherein the user input circuitry comprises an accelerometer.

22. The system of claim 19, wherein the user input circuitry comprises a gyroscope.

23. The system of claim 18, wherein:
the power management device generates a second operational state query for transmission by the second wireless transceiver to the first wireless transceiver while the user input circuitry operates in the limited power mode state;
the second transceiver receives from the first wireless transceiver a second operational state response to the second operational state query; and
the power management device processes the second operational state response to determine whether the output interface is operating in the second operating state, and that further commands the user input circuitry to enter an active mode state responsive to determining that the output interface is operating in the second operating state.

24. The system of claim 18, wherein:
the entertainment device comprises first and second output interfaces each operable to output content independently to different presentation devices, the first output interface associated with the first remote control and the second output interface associated with a second remote control;
the first output interface operating in an idle state and the second output interface operating in an active state;
the first remote control operable to transmit the first operational state query regarding the first output interface to the first wireless transceiver and to receive the first operational state response to the first operational state query, wherein the power management device commands the user input circuitry to enter the limited power mode state responsive to determining that the first output interface is operating in the idle state;
the second remote control operable to transmit a second operational state query regarding the second output interface to the first wireless transceiver and to receive a second operational state response to the second operational state query, wherein the second remote control remains in an active mode state responsive to determining that the second output interface is operating in the active state.

25. A method of placing a remote control in a limited power mode state, the method comprising:
transmitting an operational state query from a remote control to a controlled device, the controlled device having at least a first operating state and a second operating state;
receiving an operational state response from the controlled device responsive to the operational state query;
determining whether the controlled device is operating in the first operational state based on the operational state response; and
commanding components of the remote control to enter a limited power mode state responsive to determining that the controlled device is operating in the first operational state.
